(19) United States
(12) Patent Application Publication
(10) Pub. No.: US 2026/0140528 A1
(43) Pub. Date: May 21, 2026

(54) THIN INDUCTION SET HOLDER FOR VEHICLE FOOT PEDAL ASSEMBLY

(71) Applicant: CTS CORPORATION, Lisle, IL (US)

(72) Inventors: Hailin Chen, Zhongshan City (CN); Juwen Cheng, Zhongshan City (CN); XiaoXiao Lu, Granger, IN (US); Ryan Paull, Houghton, MI (US)

(21) Appl. No.: 19/390,145

(22) Filed: Nov. 14, 2025

Related U.S. Application Data
(60) Provisional application No. 63/721,883, filed on Nov. 18, 2024.

(51) Int. Cl. G05G 1/44; G05G 1/38; G05G 5/05

(52) U.S. Cl. CPC G05G 1/44; G05G 1/38; G05G 5/05

(57) ABSTRACT

A foot pedal assembly including, according to one example, a foot pad extending lengthwise between a first end and a second end, a pedal base having a hinge end and a projection end, the projection end including a projection inwardly oriented toward the foot pad and having a pedal base ramp face. A flexible hinge may couple the first end of the foot pad to the hinge end of the pedal base. A target holder may be mounted toward the second end of the foot pad, the target holder having a target holder end projection with a target holder ramp face in contact with the pedal base ramp face. Application of force to the foot pad causes movement of the target holder ramp face toward the second end of the foot pad while maintaining contact with the pedal base ramp face.

### RELATED APPLICATIONS

This application claims priority to U.S. Provisional Patent Application No. 63/721,883 filed Nov. 18, 2024, the entire content of which is incorporated herein by reference.

### FIELD

The disclosure herein relates to a vehicle foot pad assembly and, more specifically, to structures, systems, and methods for providing a thin low displacement vehicle pedal.

### BACKGROUND

Typical pedal systems for vehicles include an accelerator pedal and a brake pedal. Each pedal includes targets for transferring electrical signals to a printed circuit board (PCB). The targets are oriented vertically and movable with a pad. The PCB is also oriented vertically to sense the movement of the targets. The orientation of the target and the PCB results in the entire pedal structure or the pad being too thick or extending too high when mounted in a vehicle. A low displacement vehicle pedal is disclosed in U.S. Pat. No. 10,175,712, which is assigned to CTS Corporation.

### SUMMARY

Aspects of the present disclosure are directed to systems and methods for providing a thin, low-displacement vehicle pedal assembly that does not have a large height when mounted on a floor in a vehicle. A printed circuit board disposed in an induction set holder recess is parallel with the foot pad.

In one example, the techniques described herein relate to a foot pedal assembly for a vehicle including: a foot pad extending lengthwise between a first end and a second end; a pedal base having a hinge end and a projection end, the projection end including a projection inwardly oriented toward the foot pad and having a pedal base ramp face; a flexible hinge coupling the first end of the foot pad to the hinge end of the pedal base; and a target holder mounted toward the second end of the foot pad, the target holder having a target holder end projection at an end thereof, the target holder end projection having a target holder ramp face; wherein the target holder ramp face of the target holder end projection is in contact with the pedal base ramp face of the projection of the pedal base, and application of force to the foot pad causes movement of the target holder ramp face toward the second end of the foot pad while maintaining contact with the pedal base ramp face.

In one example, the techniques described herein relate to an induction set holder including: an induction set holder recess for receiving a printed circuit board; a U-shaped portion extending about an outer edge on three sides of the induction set holder; a spring holder projecting inwardly from an upper edge of the U-shaped portion; and a spring disposed between the spring holder and the induction set holder recess for engaging a target holder received by the induction set holder.

In one example, the techniques described herein relate to a foot pedal assembly for a vehicle including: a foot pad extending lengthwise between a first end and a second end; a pedal base having a hinge end and a projection end, the projection end of the pedal base including an inwardly oriented projection having a pedal base ramp face; a flexible hinge that couples the first end of the foot pad to the hinge end of the pedal base; a target holder; a printed circuit board; and an induction set holder including an induction set holder recess for receiving the printed circuit board, a U-shaped portion extending about an outer edge on three sides of the induction set holder, a spring holder projecting inwardly from an upper edge of the U-shaped portion, a spring held by the spring holder for engaging the target holder, and opposing inwardly oriented upper lips projecting inwardly toward each other for receiving the target holder.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate examples, instances, and/or aspects of concepts that include the claimed subject matter, and explain various principles and advantages of examples, instances, and/or aspects.

FIG. 1 illustrates a perspective top view of a low displacement vehicle foot pedal assembly including a foot pad according to one example.

FIG. 2 is a perspective bottom view of the foot pad of the low displacement vehicle pedal assembly of FIG. 1, according to one example.

FIG. 3 is a perspective side view of the low displacement vehicle pedal assembly of FIG. 1 including the foot pad, a pedal base, and an induction set holder, according to one example.

FIG. 4 is a bottom view of the low displacement vehicle pedal assembly of FIG. 1, according to one example.

FIG. 5 is a perspective view of the induction set holder with a printed circuit board, according to one example.

FIG. 6 is a perspective top view of a target holder, according to one example.

FIG. 7 is a perspective bottom view of the target holder, according to one example.

FIG. 8 is a perspective view of the target holder with a first and a second targets located therein according to one example.

FIG. 9 is a perspective view of a partially assembled foot pedal assembly including the induction set holder with the target holder received therein according to one example.

FIG. 10 is a cross-sectional view taken along line X-X of FIG. 4 illustrating the foot pedal assembly in a first position according to one example.

FIG. 11 illustrates the foot pedal assembly in a second, position, according to one example.

FIG. 12 illustrates an induction set holder according to another example.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples.

The apparatus and method components have been represented where appropriate by conventional symbols in the drawings, showing only those specific details that are pertinent to understanding the examples, instances, and aspects illustrated so as not to obscure the disclosure with details that will be readily apparent to those of ordinary skill in the art having the benefit of the description herein.

### DETAILED DESCRIPTION

One or more aspects are described and illustrated in the following description and accompanying drawings. These aspects are not limited to the specific details provided herein and may be modified in various ways. Furthermore, other aspects may exist that are not described herein. For example, a device or structure that is “configured” in a certain way is configured in at least that way but may also be configured in ways that are not listed.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms, for example, first and second, top and bottom, and the like may be used herein solely to distinguish one entity or action from another entity or action without necessarily requiring or implying any actual such relationship or order between such entities or actions.

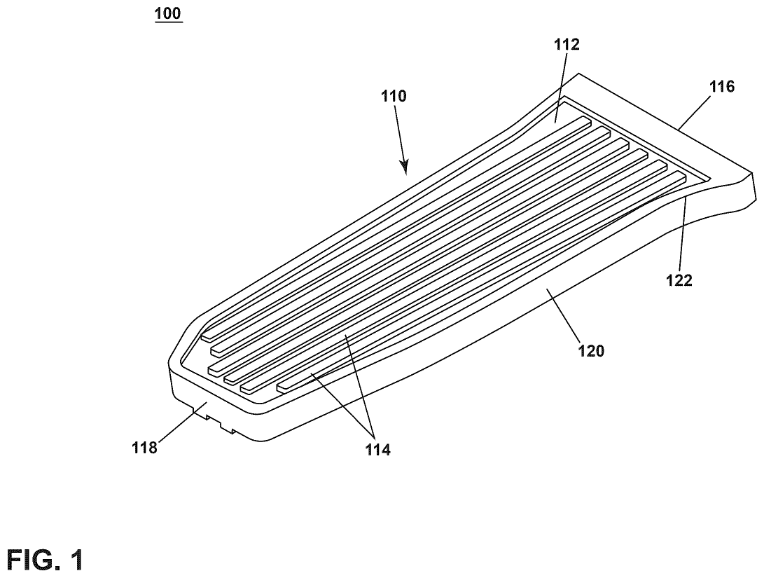

FIG. 1 illustrates a perspective top view of an example low displacement vehicle foot pedal assembly 100, or pedal assembly 100, adapted for use with systems and methods of the present disclosure. The pedal assembly 100 provides for a compact in height, low displacement vehicle foot pedal assembly. The pedal assembly 100 is included in and operatively connected to a vehicle (not shown). The pedal assembly 100 includes a foot pad 110 that receives contact from a foot of a user via an upper surface 112 of the foot pad 110 to operate the vehicle (e.g., accelerate, brake). In the example shown, the foot pad 110 includes longitudinal extensions or treads 114 on the upper surface 112 of the foot pad 110 for providing grip to a foot of a user. The foot pad 110 extends lengthwise from a first end 116 to a second end 118. A lip 120 may extend from the upper surface 112 downward and follow a perimeter 122 of the foot pad 110.

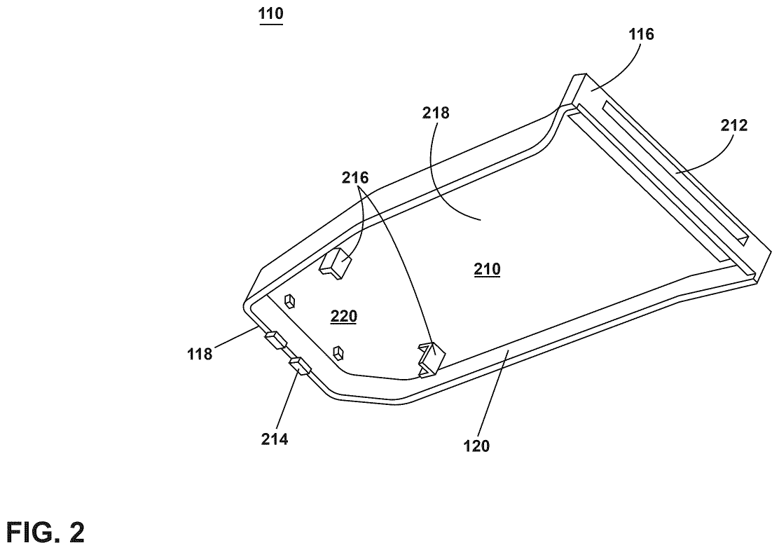

FIG. 2 illustrates a perspective bottom view of the foot pad 110 of the pedal assembly 100 from FIG. 1. It can more clearly be seen that the lip 120 may define a housing 210 for receiving parts of the pedal assembly 100. In one example a slot 212 is provided in the lip 120 at the first end 116. A set of holders 214 (e.g., a pair of tabs) may extend from the lip 120 at the second end 118. A set of guides 216 may extend from a lower surface 218 of the foot pad 110 and are spaced from the second end 118. Together the lip 120 at the second end 118, the set of holders 214, and the set of guides 216 define an induction set area 220 of the housing 210.

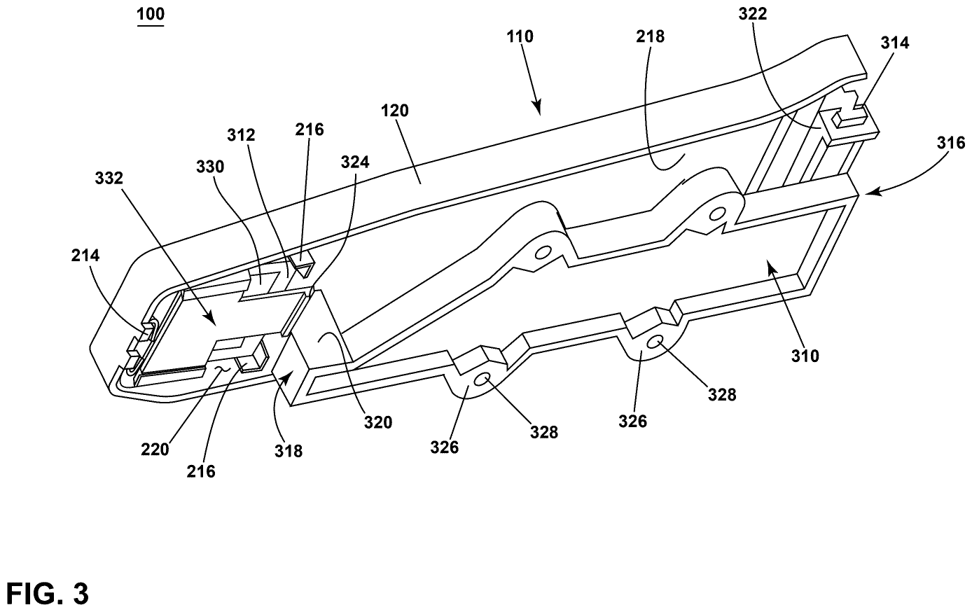

FIG. 3 is a perspective view of the pedal assembly 100 including the foot pad 110, with a pedal base 310 and an induction set holder 312. A flexible hinge 314 may be provided at the first end 116 of the foot pad 110. In one example, the flexible hinge 314 is inserted, or otherwise received in the slot 212 (FIG. 2). The flexible hinge 314 may connect the foot pad 110 to the pedal base 310. In some examples, the flexible hinge 314 is formed of a sturdy elastic material such as nitrile. Nitrile is a synthetic rubber copolymer formed from acrylonitrile and butadiene. In some instances, the flexible hinge 314 is formed of one or more other elastic polymer and/or rubber materials.

The pedal base 310 is spaced from the lower surface 218 of the foot pad 110 and extends lengthwise between a hinge end 316 and a projection end 318. The pedal base 310 may include a receiver 322 at the hinge end 316 for receiving the flexible hinge 314. The projection end 318 may include a projection 320 projecting inwardly with respect to the pedal assembly 100, or upwardly toward the lower surface 218 of the foot pad 110. The projection 320 includes a pedal base ramp face 324 facing upwardly and outwardly. The pedal base ramp face 324 is angled and oriented toward the induction set area 220. The pedal base 310 includes a set of projections 326 (e.g., mounting knobs) and apertures 328 within each projection 326. The apertures 328 are provided to receive fasteners (not shown) for securing the pedal base 310 to a vehicle floor of a vehicle.

The induction set holder 312 may be secured by the set of guides 216 and maintained by the set of guides 216 within the induction set area 220. The induction set holder 312 has a thin profile. For example, a thin profile is one in which the of thickness of the set holder 312 is small compared to its height and width. The induction set holder 312 is configured to receive a printed circuit board (PCB) 330 in surface-to-surface contact therewith. A target holder 332 sandwiches the PCB 330 to the induction set holder 312. The target holder 332 is cutaway to show a first target 334 and a second target 336 located within the target holder 332. When assembled, the foot pad 110 and the PCB 330 each define a plane (shown as plane # and plane #). The planes # and # are essentially parallel to each other. Having the PCB 330 oriented in this manner reduces the size/width of the foot pad 110 and the induction set holder 312. During assembly, the induction set holder 312 is inserted into the induction set area 220 of the foot pad 110 and retained by the set of guides 216 and set of holders 214. Thereafter, the induction set holder 312 is in surface-to-surface contact with the foot pad 110.

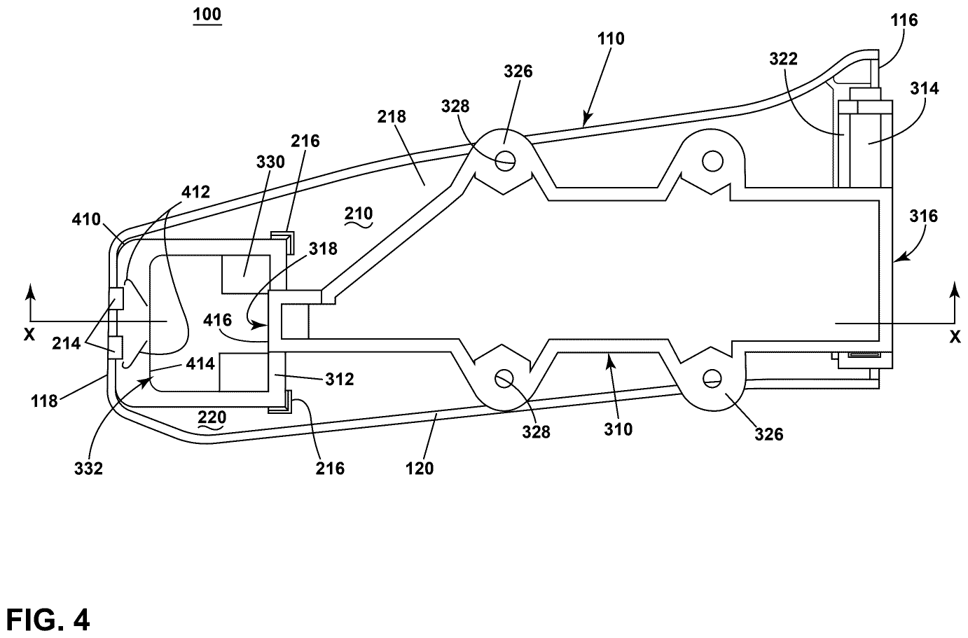

FIG. 4 illustrates a bottom view of the pedal assembly 100 from FIG. 3. A profile and shape corresponding to each of the foot pad 110, the pedal base 310, the induction set holder 312, and the target holder 332 are more clearly shown. The induction set holder 312 is held in place within the induction set area 220 of the housing 210. The induction set holder 312 has a substantially square shape with a U-shaped portion 410 on a side facing the lip 120 of the foot pad 110. The U-shaped portion 410 may be elongated and extend about an outer edge on three sides of the induction set holder 312.

A set of springs 412 are secured to the induction set holder 312 and configured to hold the target holder 332 in place. The target holder 332 has a T-shape having a wide T-side 414 and a narrow T-side 416. The set of springs 412 engage the target holder 332 and, when compressed, apply a force onto the wide T-side 414 of the target holder 332 toward the pedal base 310. In the example illustrated, the set of springs 412 are V-shaped springs. The set of springs 412 may be mounted to the induction set holder 312 any time before the target holder 332 is inserted. While V-shaped springs are illustrated, other types of springs or spring-like members are contemplated.

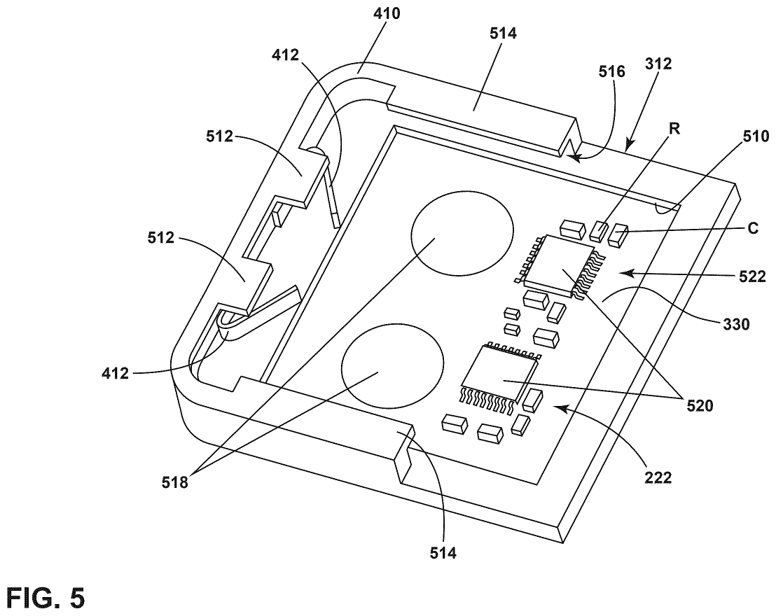

FIG. 5 is a perspective view of the induction set holder 312 including the PCB 330. The induction set holder 312 includes an induction set holder recess 510 located within. The U-shaped portion 410 includes a pair of inwardly oriented spring holders 512 configured to be received by and parallel to the set of holders 214 (FIG. 4). In one example, the set of springs 412 are V-shaped and mounted to the induction set holder 312 via the spring holders 512. The U-shaped portion 410 extends about an outer edge on three sides of the induction set holder 312. Opposing sides of the U-shaped portion 410 have inwardly oriented upper lips 514 at a top edge projecting toward each other to define a slot 516 for receiving additional elements therein.

The induction set holder recess 510 receives the PCB 330 in surface-to-surface contact therewith. The PCB 330 includes a pair of sensing/transmitting coils 518 mounted thereon. A pair of inductive integrated circuits 520, in one example application specific integrated circuits (ASIC), are also provided on the PCB 330. In some examples, the pair of inductive integrated circuits 520 are each an inductance to digital converter. In some instances, each of the inductive integrated circuits 520 is a Texas Instruments, LDC3114-Q1 4-Channel Hybrid Inductive Touch and Inductance to Digital Converter chip. Other integrated circuits are configured to measure or sense small deflections of conductive targets can be used in other implementations. The PCB 330 may also support multiple capacitors (“C”) and resistors (“R”). Together each of the sensing/transmitting coils 518, the integrated circuits 520, and the capacitors C and resistors R define a pair of electric circuits 522. Electrical connections between various elements are not illustrated.

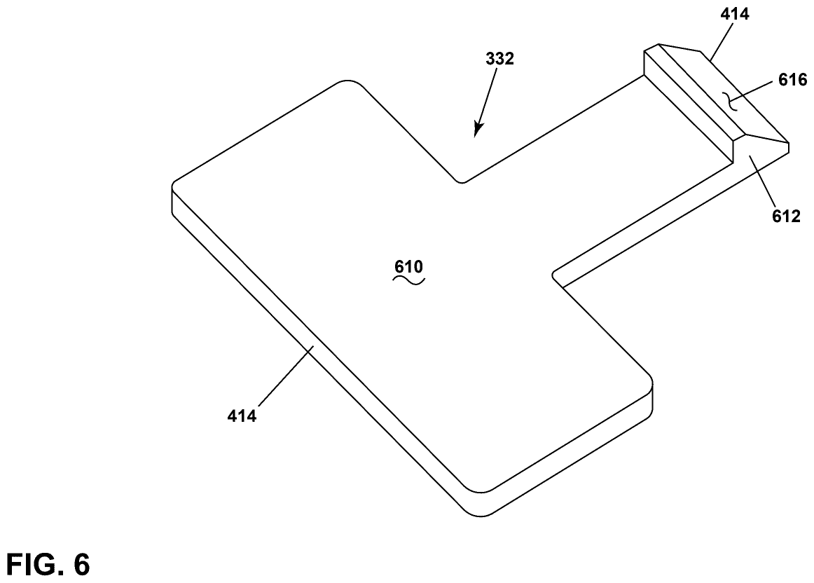

FIG. 6 is a perspective view of the target holder 332 showing an exterior surface 610 of the target holder 332. The target holder 332 includes a target holder end projection 612 at a narrow T-side 416 of the target holder 332 extending transverse to the body of the target holder 332. The target holder end projection 612 has an outwardly and upwardly oriented target holder ramp face 614.

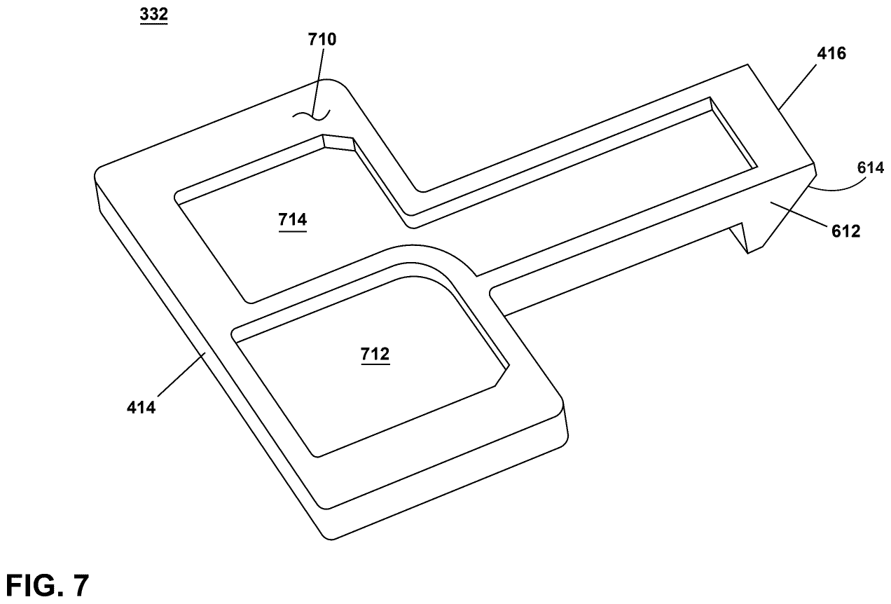

FIG. 7 is a perspective view of the target holder 332 showing an interior surface 710 of the target holder 332. The interior surface 710 includes a first target holder recess 712 and a second target holder recess 714. The first target recess 712 is formed in the wide T-side 414 while the second target holder recess 714 includes portions in the wide T-side 414 and the narrow T-side 416 of the target holder 332. In one example, the target holder 332 is made by an inset molding process.

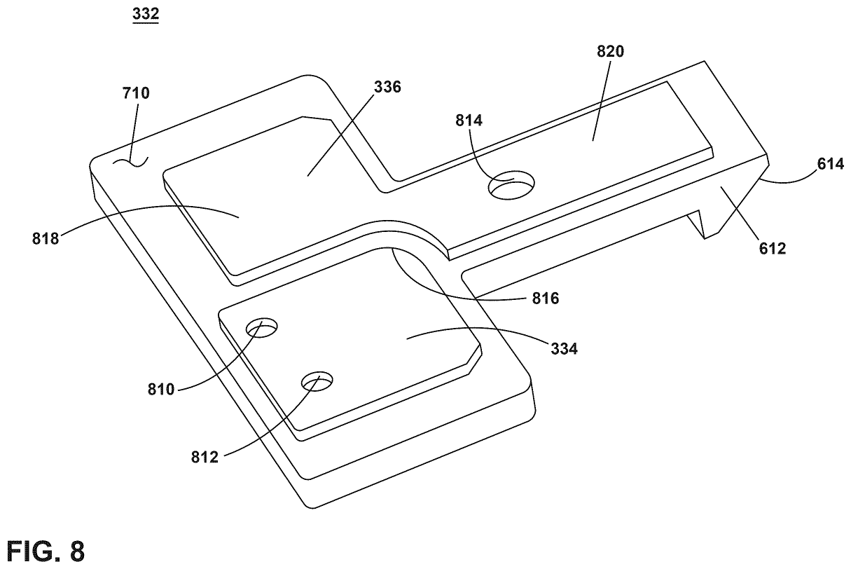

FIG. 8 is a perspective view of the target holder 332 showing the first and second targets 334, 336 located within the first and second target holder recesses 712, 714 (FIG. 7) respectively. The first target 334 includes apertures 810, 812 and the second target 336 includes at least one aperture 814. The first target 334 has an elongate shape with the apertures 810, 812 aligned equidistantly from a nearby edge at one end of the first target 334. An opposing end of the first target 334 includes at least one rounded corner 816. The second target 336 has a first portion 818 shaped similarly to the first target 334 and a narrowed portion 820 extending toward the target holder end projection 612. In one example, the surfaces of the targets 334, 336 are flush with the interior surface 710 of the target holder 332. The apertures 810, 812, 814 are provided to fix the respective targets 334, 336 in a proper position for a manufacturing process. In one example, the manufacturing process is injection molding. The apertures 810, 812, 814 can vary in amount and are not intended to change the function of the pedal assembly 100.

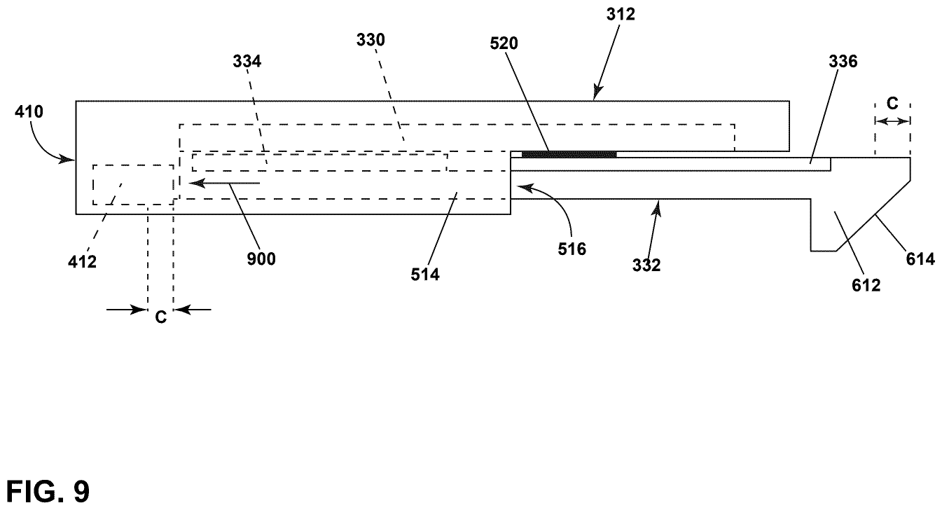

FIG. 9 is a side view of the induction set holder 312 oriented with the U-shaped portion 410 on the left and the target holder 332 received therein. During assembly the target holder 332, supporting the first and second targets 334, 336, is inserted at the wide T-side 414 into the slot 516. The PCB 330 may be mounted into the induction set holder recess 510 prior to insertion of the target holder 332. In this arrangement, the wide T-side 414 of the target holder 332 contacts the set of springs 412. During operation, the target holder 332 is moveable in a linear direction along arrow 900 and compresses the set of springs 412 a compressed amount (“C”).

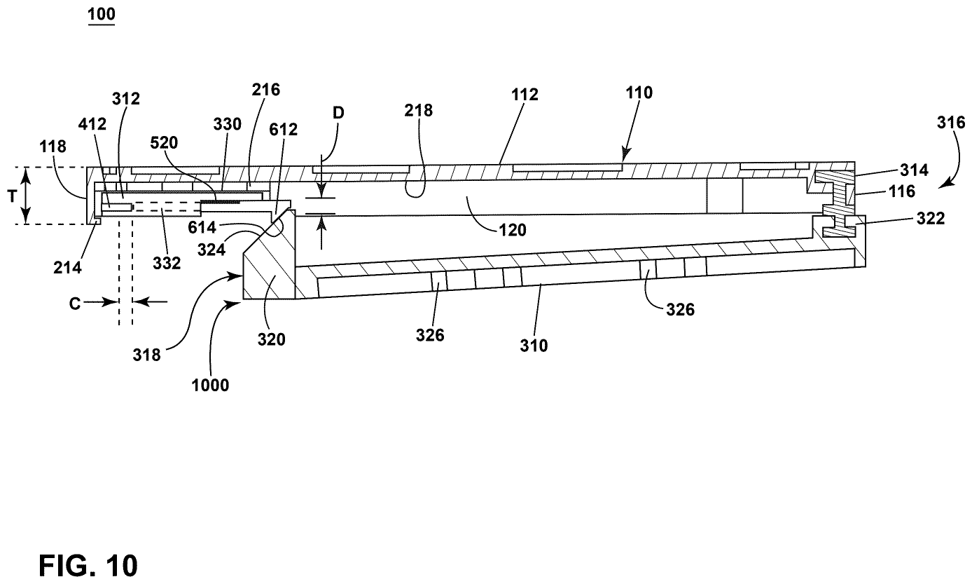

FIG. 10 illustrates the pedal assembly 100 fully assembled and in a cross-sectional view taken along line X-X of FIG. 4. The pedal assembly 100 has a thin profile and is thinner in construction than previous vehicle foot pedal assemblies. In one example, the combined foot pad 110 and the induction set holder 312 with the PCB 330 and the target holder 332 have a thickness (“T”) ranging between 25 millimeters and 40 millimeters. In some implementations the thickness is 30 mm. Other thicknesses providing a thin profile as described herein are contemplated. The pedal assembly 100 is illustrated in a first, or rest, position 1000, where no force is being applied to the foot pad 110. In the first position 1000 the projection 320 is located a low displacement (“D”) below the target holder end projection 612. In the rest position 1000, the first target 334 and second target 336 are disposed adjacent the corresponding sensing/transmitting coil of the pair of sensing/transmitting coils 518.

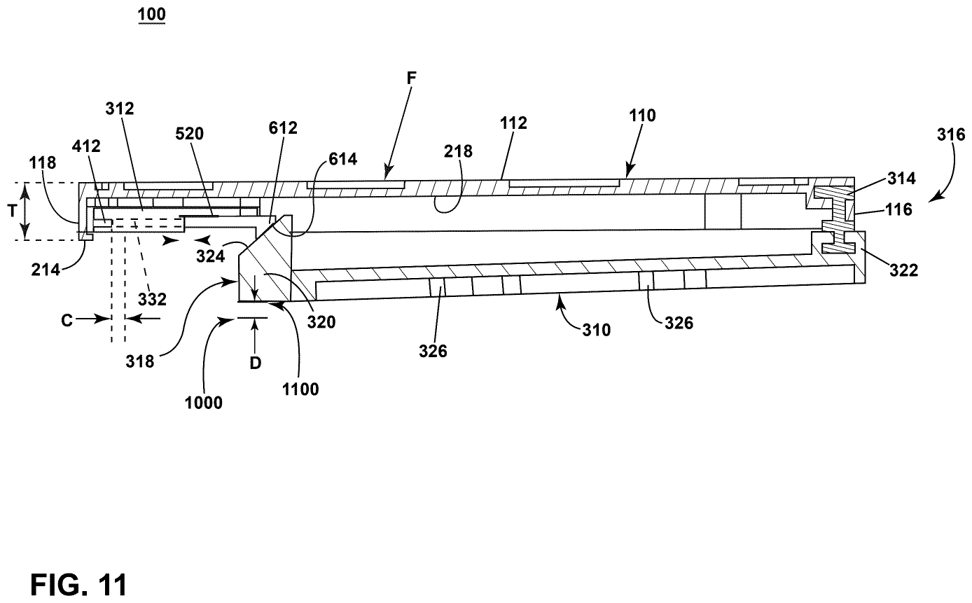

FIG. 11 illustrates the pedal assembly 100 from FIG. 10 in a second, or engaged, position 1100. A force (“F”), by way of example via a foot of an operator, is applied to the foot pad 110 to move the pedal assembly 100 from the first position 1000 to the second position 1100. The amount of force may vary depending on customer specifications and/or vehicle type. It can more clearly be seen that the thin profile of the induction set holder 312 enables the low displacement D of the pedal assembly 100 during operation.

In operation, the flexible hinge 314 is designed to experience elastic deformation when the force F is exerted on and released from the foot pad 110. That is, the flexible hinge 314 bends when the force F is applied to the foot pad 110, thereby displacing the foot pad 110 from the rest position 1000 towards the pedal base 310 into the pushed position 1100. When the force F exerted on the foot pad 110 is released, the flexible hinge 314 unbends and returns the foot pad 110 to the rest position 1000 (e.g., an idle state with no braking/accelerating). One example of a flexible hinge is set forth in Applicant's commonly owned U.S. Patent Pub. 2024-0131926, filed Oct. 10, 2023, as U.S. patent application Ser. No. 18/483,893.

In operation, as the foot pad 110 receives the force F, the flexible hinge 314 flexes structurally. Simultaneously, the target holder ramp face 614 transfers the force F to the pedal base ramp face 324 of the projection 320 of the pedal base 310 such that the target holder 332 moves downwardly and sidewardly with the pedal base ramp face 324 in surface-to-surface contact with the target holder ramp face 614. The pedal base ramp face 324 of the pedal base 310 and the target holder ramp face 614 of the target holder 332 maintain or remain in surface-to-surface contact with each other during the entire movement of the target holder 332. Thus, application of force to the foot pad 110 causes sliding movement between the target holder ramp face 614 and the pedal base ramp face 324. The overall result of the application of the force F moves the target holder 332 in a linear direction toward the set of springs 412, wherein the set of springs 412 become compressed, as can be seen when comparing the rest position illustrated in FIG. 10 to the engaged position 1100 shown.

The movement of the foot pad 110 downwardly causes the movement of the target holder 332 linearly toward the set of springs 412. FIG. 11 shows compression of the set of springs 412 when compared to the disengaged foot pad 110 shown in FIG. 10.

The movement of the target holder 332 toward the set of springs 412 results in movement of the first and second targets 334, 336 relative to the pair of sensing/transmitting coils 518 disposed on the printed circuit board 40. This movement changes the electrical fields output/sensed thereby. More specifically, the pair of sensing/transmitting coils 518 along with the pair of inductive integrated circuits 520 are part of the pair of electrical circuits 522 for sensing movement of the first and second targets 334, 336. The pair of electrical circuits 522 may be entirely separate from each other and entirely separate in operation.

The force F applied to the foot pad 110 results in a slight linear movement (right to left) of the target holder 332. The shifting or movement of the targets 334, 336 toward the set of springs 412 is detected by corresponding circuits in the pair of inductive integrated circuits 520. Output values from the pair of inductive integrated circuits 520 are provided to a vehicle control device (not shown) that controls acceleration/braking of a vehicle for example.

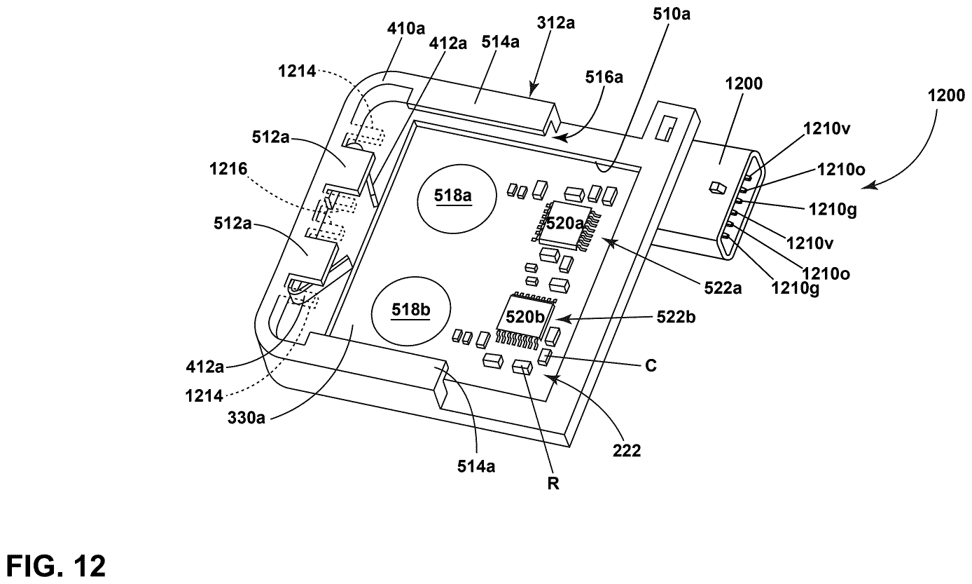

FIG. 12 illustrates another induction set holder 312a according to an example and including a PCB 330a. The induction set holder 312a includes a recess 510a centrally located within. A U-shaped portion 410a of the induction set holder 312a includes a pair of inwardly oriented spring holders 512a. A set of springs 412a may be secured to the induction set holder 312a via the spring holders 512a. Opposing sides of the U-shaped portion 410a have inwardly oriented upper lips 514a projecting toward each other for receiving additional elements therein that are movable within the induction set holder 312a in one direction, such as the target holder 332.

In one example, the induction set holder 312a includes a connection cover 1200 projecting from a corner of the induction set holder 312a. A plurality of electrical connectors 1210 project outwardly in parallel with each other from the PCB 330 and into the connection cover 1200.

A first connector 1210v is a voltage input connector for providing voltage to a first electric circuit 522a. The first electric circuit 522a including a sensing/transmitting coil 518a and a first inductive integrated circuit 520a. A second connector 1210o provides an output from the first electric circuit 522a. In one example, the output is a digital value. A third connector 1210g provides a ground connection for the first electrical circuit 522a.

Similarly, a fourth connector 1212v is a voltage input connector for providing voltage to a second electric circuit 522b. The second electric circuit 522a including a second sensing/transmitting coil 518b and a second inductive integrated circuit 520b. A fifth connector 1212o provides an output from the second electric circuit 522b. In one example, the output is a digital value. A sixth connector 1212g is a ground connection for the second electrical circuit 522b.

In operation, the plurality of electrical connectors 1210 provide signals from each of the sensing arrangements to a vehicle control device (for example, a computer, not shown) that controls acceleration/braking of a vehicle for example. In some examples, the signals are digital signals.

In one example, the spring holders 512a may include outer tabs 1214 and inner tabs 1216 projecting upwardly from the induction set holder 312a and integral with spaced parts of the U-shaped portion 410a. In this example, the set of springs 412a may be snap fit in contact with the spring holders 512a, the outer tabs 1214, and the inner tabs 1216.

In some instances, the vehicle foot pedal assembly is associated with a passenger vehicle, such as a car or a light truck. In some instances, the vehicle is a commercial vehicle, such as a van, a bus, a box truck, or a semi-truck. In some instances, the vehicle is a small vehicle such as a motorcycle, a scooter, or an all-terrain vehicle. In some instances, the vehicle is a low-speed vehicle such as a golf cart or a utility cart. In some instances, the vehicle is powered by an internal combustion engine. In some instances, the vehicle is an electric vehicle. In some instances, the pedal is included in and connected to other types of vehicles.

In the foregoing specification, specific examples have been described. However, one of ordinary skill in the art appreciates that various modifications and changes may be made without departing from the scope of the examples as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The forgoing is defined solely by the appended claims including any amendments made during the pendency of this application and all equivalents of those claims as issued.

In addition, unless the context of their usage unambiguously indicates otherwise, the articles “a” and “an” should not be interpreted as meaning “one” or “only one.” Rather these articles should be interpreted as meaning “at least one” or “one or more”.

The abstract is provided to allow the reader to quickly ascertain the nature of the technical disclosure. It is submitted with the understanding that it will not be used to interpret or limit the scope or meaning of the claims. In addition, in the foregoing detailed description, it may be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the detailed description, with each claim standing on its own as a separately claimed subject matter.

We claim:

1. A foot pedal assembly for a vehicle comprising:
a foot pad extending lengthwise between a first end and a second end;
a pedal base having a hinge end and a projection end, the projection end including a projection inwardly oriented toward the foot pad and having a pedal base ramp face;
a flexible hinge coupling the first end of the foot pad to the hinge end of the pedal base; and
a target holder mounted toward the second end of the foot pad, the target holder having a target holder end projection at an end thereof, the target holder end projection having a target holder ramp face;
wherein the target holder ramp face of the target holder end projection is in contact with the pedal base ramp face of the projection of the pedal base, and application of force to the foot pad causes movement of the target holder ramp face toward the second end of the foot pad while maintaining contact with the pedal base ramp face.

2. The foot pedal assembly of claim 1, further comprising an induction set holder including a spring and a spring holder configured to receive the spring;
wherein the spring is configured to apply engage the target holder; and
wherein application of force to the foot pad causes the target holder to compress the spring while moving the target holder in a linear direction toward the spring.

3. The foot pedal assembly of claim 2, wherein the induction set holder includes an induction set holder recess and the target holder includes a first target holder recess and a second target holder recess, the foot pedal assembly further including:
a printed circuit board disposed in the induction set holder recess;
a pair of sensing/transmitting coils disposed on the printed circuit board;
a first target disposed in the first target holder recess; and
a second target disposed in the second target holder recess,
wherein, at rest, the first target is disposed adjacent a first of the pair of sensing/transmitting coils and the second target is disposed adjacent a second of the pair of sensing/transmitting coils.

4. The foot pedal assembly of claim 3, wherein the induction set holder includes a U-shaped portion extending about an outer edge on three sides of the induction set holder.

5. The foot pedal assembly of claim 4, wherein the U-shaped portion of the induction set holder includes opposing inwardly oriented upper lips projecting inwardly from opposing sides of the induction set holder.

6. The foot pedal assembly of claim 5, wherein the inwardly oriented upper lips of the induction set holder maintain the target holder within the induction set holder.

7. The foot pedal assembly of claim 3, wherein when the application of force to the foot pad moves the target holder in a linear direction toward the spring, the first target and the second target move relative to the pair of sensing/transmitting coils.

8. The foot pedal assembly of claim 7, including:
a first electrical circuit including the first of the pair of sensing/transmitting coils and a first inductive integrated circuit; and
a second electrical circuit including the second of the pair of sensing/transmitting coils and a second inductive integrated circuit.

9. The foot pedal assembly of claim 2, wherein the induction set holder includes an induction set holder recess, the foot pedal assembly further including:
a printed circuit board disposed in the induction set holder recess, the printed circuit board being parallel with the foot pad.

10. The foot pedal assembly of claim 1, wherein when the application of force to the foot pad causes movement of the target holder ramp face, the target holder ramp face of the target holder remains in surface-to-surface contact with the pedal base ramp face of the pedal base.

11. A foot pedal assembly for a vehicle comprising:
a foot pad extending lengthwise between a first end and a second end;
a pedal base having a hinge end and a projection end, the projection end of the pedal base including an inwardly oriented projection having a pedal base ramp face;
a flexible hinge that couples the first end of the foot pad to the hinge end of the pedal base;
a target holder;
a printed circuit board; and
an induction set holder including an induction set holder recess for receiving the printed circuit board, a U-shaped portion extending about an outer edge on three sides of the induction set holder, a spring holder projecting inwardly from an upper edge of the U-shaped portion, a spring held by the spring holder for engaging the target holder, and opposing inwardly oriented upper lips projecting inwardly toward each other for receiving the target holder.

12. The foot pedal assembly of claim 11, wherein the target holder includes a first target and a second target disposed thereon.

13. The foot pedal assembly of claim 12, including first and second sensing/transmitting coils disposed on the printed circuit board.

14. The foot pedal assembly of claim 13, including a first inductive integrated circuit and a second inductive integrated circuit disposed on the printed circuit board.

15. The foot pedal assembly of claim 11, further comprising tabs spaced from each other and on either side of the spring holder, wherein the tabs and the spring holder are configured to receive the spring, and the spring is compressed by movement of the target holder when an applied force moves the foot pad.

16. The foot pedal assembly of claim 15, wherein the spring is a V-shaped spring.

17. An induction set holder comprising:
an induction set holder recess for receiving a printed circuit board;
a U-shaped portion extending about an outer edge on three sides of the induction set holder;
a spring holder projecting inwardly from an upper edge of the U-shaped portion; and
a spring disposed between the spring holder and the induction set holder recess for engaging a target holder received by the induction set holder.

18. The induction set holder of claim 17, wherein the U-shaped portion of the induction set holder includes opposing inwardly oriented upper lips projecting inwardly toward each other from opposing sides of the induction set holder for receiving and maintaining the target holder within the induction set holder.

19. The induction set holder of claim 17, further comprising an outer tab and an inner tab on either side of the spring holder, the outer tab and the inner tab each projecting upwardly from the induction set holder and integral with the U-shaped portion.

20. The induction set holder of claim 19, wherein the spring includes a V-shaped spring that is secured between the outer tab and the inner tab and below the spring holder.
